(19) United States
(12) Patent Application Publication
(10) Pub. No.: US 2026/0330721 A1
(43) Pub. Date: Oct. 22, 2026

(54) System and Method for AI-Based Generation of Time-Constrained Presentation Content Using Presentation Duration, Speaking Pace, Presentation Type, and Speaker Notes Format

(71) Applicant: Kate Elspeth Steinmeyer, East Palo Alto, CA (US)

(72) Inventor: Kate Elspeth Steinmeyer, East Palo Alto, CA (US)

(21) Appl. No.: 19/193,996

(22) Filed: Apr. 30, 2025

Related U.S. Application Data
(60) Provisional application No. 63/791,213, filed on Apr. 18, 2025.

(51) Int. Cl. G06T 11/60

(52) U.S. Cl. CPC G06T 11/60; G06T 2200/24

(57) ABSTRACT

A system and method for generating time-constrained presentation content using AI, based on user-defined inputs including total presentation time, speaking pace, presentation format, and speaker notes format. The system calculates pacing logic from these inputs to generate a sequence of slides and corresponding speaker notes aligned with the available presentation duration. Speaker notes are generated in either bullet point or full script format, scaled to match the estimated duration of each slide or video segment. In some embodiments, a custom speaking pace is determined by prompting the user to read a sample text aloud and calculating a words-per-minute (WPM) rate. If an AI generation engine is unavailable, fallback logic applies rule-based formulas and predefined content templates to generate slides and narration. The system dynamically adapts to user delivery constraints and format preferences, ensuring consistent pacing, narrative coverage, and usability under both AI-enabled and fallback conditions. In some embodiments, the system includes an AI assistant that interactively collects inputs and refines outputs.

### BACKGROUND OF THE INVENTION

Traditional presentation tools, including those utilizing AI-assisted slide generation, primarily emphasize visual content layout and formatting. However, they often fail to dynamically account for critical delivery constraints such as total available time, user speaking pace, and synchronized speaker notes formatting. As a result, generated presentations are frequently poorly paced—either too dense to complete within the allotted time or too sparse to sustain the intended session duration.

Existing systems also fail to adapt speaker narration or guidance to match the structure and timing of each slide. Presenters are left without synchronized talking points, creating a disconnect between content generation and actual delivery performance. This deficiency increases the risk of inconsistent pacing, reduced audience engagement, and delivery errors.

Accordingly, there exists a need for a system that, based on user-defined delivery parameters—including total time duration, speaking pace, presentation type (e.g., demo, pitch, screen-recorded walkthrough), and desired speaker notes format—dynamically generates both a slide sequence and time-aligned speaker narration. Unlike static slide-building tools, the present invention ensures that all output (visual and textual) is precisely aligned with the user's available delivery window and personalized delivery style, improving pacing consistency, usability, and overall presentation effectiveness.

In contrast to prior systems that emphasize emotional engagement prediction, narrative arc selection, or audience response visualization, the present invention addresses a different technical challenge: dynamically generating presentation content that is precisely constrained by a user's specified time duration, speaking pace, presentation format, and speaker notes preference. The invention ensures that both the visual slide content and the corresponding speaker narration are tightly aligned with the available delivery window, regardless of AI availability. As a result, the system improves pacing consistency, enhances delivery effectiveness, and supports time-bound usability across diverse presentation formats.

The invention provides a system and method for generating AI-powered, time-constrained presentation content based on a defined set of delivery parameters: presentation topic, total presentation duration, speaker pace, presentation format, and speaker notes format. Based on these inputs, an AI generation engine dynamically constructs both the slide sequence and corresponding narration script such that the total content precisely fits the specified delivery time. In embodiments where AI is unavailable, a fallback logic engine ensures time-constrained presentation content remains consistent using rule-based estimation methods.

### SUMMARY OF THE INVENTION

The invention provides a system and method for generating AI-powered time-constrained presentation content based on a small set of delivery inputs: presentation topic, total presentation time, speaker pace, presentation format, and speaker notes preference. These inputs guide an AI generation engine in creating both the slide structure and corresponding narration script, such that the total content precisely fits the allotted delivery time.

The system calculates pacing logic from the inputs to determine the number of slides and their density, while simultaneously generating speaker notes—either as bullet points or full script—aligned with each slide's estimated duration. In scenarios where AI is unavailable, a fallback logic engine applies rule-based estimation formulas and template-driven content insertion to maintain timing integrity.

The result is a flexible, intelligent system that delivers consistent, time-bound presentation experiences, regardless of delivery format or technical availability.

As used herein, the term “custom speaking pace” refers to an individualized measurement of a user's verbal delivery speed, typically expressed in words per minute (WPM). In some embodiments, the system determines the custom speaking pace by prompting the user to read a sample paragraph aloud, recording the spoken output, and calculating the WPM based on the duration and content of the sample. This measurement allows the system to dynamically adjust slide pacing, speaker notes length, and overall presentation structure to better align with the user's natural speaking rhythm, thereby improving time management and delivery consistency.

As used herein, the term “speaker notes” refers to AI-generated or dynamically constructed text-based guidance intended for use by the presenter during live or recorded delivery of a presentation. Speaker notes may include bullet points, full script narratives, time duration estimates, or instructional prompts associated with individual slides or video segments. In various embodiments, the speaker notes are generated in alignment with the user's defined total time, speaking pace, and presentation type to ensure synchronized delivery. The speaker notes are not intended for direct audience consumption but rather serve to assist the presenter in maintaining pacing, structure, and narrative coherence throughout the delivery.

As used herein, the terms “AI assistant” and “AI assistant interface” are used interchangeably to refer to the user-facing component of the system that facilitates input collection, preview interaction, and real-time refinement. In some cases, the AI assistant interface may be supported by an underlying dialogue engine or model that processes conversational logic and generation prompts. The term “AI engine” refers to the backend processing component that generates slide content, speaker notes, and pacing logic based on input parameters received through the assistant interface or directly via forms. The AI assistant interface and AI engine may operate in tandem but are implemented as logically and functionally distinct components. Although the described AI assistant interface is illustrated using a visual UI, in some embodiments the interface may instead be implemented as a voice-based assistant or chatbot system.

As used herein, the term “slide” refers to any discrete unit of presentation content generated or processed by the system, including but not limited to visual slides, embedded video segments, animated demonstrations, or interactive media elements. Unless context specifically requires otherwise, features described in relation to slides apply equally to these alternate content formats within the presentation sequence.

### User Input Interface

Users interact with an interface that includes the following configurable inputs:

Presentation Topic: User enters a brief topic description, which guides the AI content generation.

Presentation Type: Options include Standard Presentation, Demo, Presentation with Demo, or Presentation with Screen Recording or Video.

Time Duration: Preset values (5, 10, 20, 30 minutes) or a custom input.

Speaking Pace: User selects one of Fast, Average, Slow, or Custom.

Speaker Notes Format: Options include None, Bullet Points, or Full Script. This determines how the system structures the narration per slide. If “None” is selected, no speaker notes are generated. If “Bullet Points” or “Full Script” is selected, the speaker notes are created to match the user's speaking pace and presentation duration.

In some embodiments, the user input interface may be presented as a series of progressive screens during onboarding or the user's first use. In subsequent uses, all input selections may be consolidated into a single screen for faster configuration.

In some embodiments, the speaker notes may include a time estimate displayed adjacent to each note block or slide, indicating the expected speaking duration for that section. This feature enables presenters to pace their delivery more effectively and monitor timing consistency during the preparation process.

### Slide Generation Logic

Upon receiving the user inputs, the system estimates the average speaking time per slide based on the selected speaking pace. For example, the system may assume approximately 30 seconds per slide for a fast speaker, approximately 1 minute per slide for an average speaker, and approximately 1.5 minutes per slide for a slow speaker.

The system calculates the optimal number of slides by dividing the total presentation time by the estimated average time per slide.

The system adjusts the expected content density per slide based on the selected presentation type. In some embodiments, a demo presentation emphasizes more visuals and less text. A standard presentation maintains a balance of text and visuals. A presentation with demo components alternates between explanation slides and demo support slides. Presentations with screen recordings or video inserts allocate placeholder slides for video segments and reduce content density elsewhere to fit within the overall time limit.

After determining the pacing and content distribution, the system generates a slide sequence using an AI model, informed by the user's input values.

### EXAMPLE

In one example embodiment, a user selects “Presentation with Demo,” specifies a 5-minute total duration, and selects Average as the desired speaking pace. The system calculates an estimated one minute per slide, resulting in approximately five slides for the presentation. Slide pacing alternates between explanation-focused slides and demo-support visuals, structured to suit the compressed time constraint.

### Example Use Cases

In an embodiment related to investor pitches, a startup founder selects the “Standard Presentation” type, sets a 10-minute duration, and chooses a fast speaking pace with bullet point speaker notes. The system generates approximately 20 concise slides and corresponding high-level talking points.

In an embodiment for technical demonstrations, a product manager selects “Presentation with Demo,” a 15-minute duration, an average speaking pace, and full script speaker notes. The system alternates between slide visuals and demo support slides, generating detailed narration to guide the live demonstration.

In an embodiment for pre-recorded webinars, a marketing lead selects “Presentation with Screen Recording or Video,” sets a 30-minute duration, and an average speaking pace. The system inserts placeholder slides for video segments and adjusts slide density elsewhere.

In an embodiment for sales enablement training, an internal trainer selects the “Demo Only” presentation type, a 5-minute duration, a slow pace, and full script speaker notes. The system generates a low-slide-count deck emphasizing visuals, with template-based narration.

### Fallback Behavior—Calculation-Based Estimation

In the event that the AI model is unavailable, unresponsive, or produces unusable output, the system initiates a rule-based fallback logic based on rule-based calculations. These fallback calculations rely on the user's selected parameters, including total presentation time, speaking pace, and presentation type.

A slide pacing formula is applied to estimate the total number of slides, where estimated slides equals total minutes divided by a slide duration factor. For example, fast pace uses approximately 0.5 minutes per slide, average pace uses approximately 1 minute per slide, and slow pace uses approximately 1.5 minutes per slide.

The system generates a placeholder slide structure using predefined templates appropriate for the selected presentation type, such as introduction slides, key points, and conclusion slides. This ensures users receive functional time-constrained presentation content maintaining timing and pacing consistency even without AI output.

### Speaker Notes Generation Based on Timing

The system generates suggested speaker notes aligned with the estimated slide pacing. For each slide, the system calculates the approximate available speaking duration and generates a corresponding text block.

If AI generation resources are available, the speaker notes are dynamically authored to match the visual content and timing constraints.

If fallback logic is used, the speaker notes are created from pre-written templates that correspond to slide types, adjusted to fit the expected speaking time.

These generated speaker notes provide presenters with structured narration aligned to slide progression and overall presentation timing, regardless of generation path.

### BRIEF DESCRIPTION OF THE DRAWINGS

FIG. 1 is a system flowchart illustrating the logic path from initial presentation setup through AI or fallback generation of slides and speaker notes, followed by user preview and selection of edit or presentation mode.

FIG. 2 is a block diagram illustrating the system architecture for AI-based and fallback presentation generation, including logic processor modules, template databases, and output interfaces.

FIG. 3 is a flowchart illustrating the conversational dialogue flow between the AI assistant and the user for dynamically collecting presentation parameters, generating time-constrained presentation content, continuing through a preview and editing phase including tile view, list view, slide detail editing, and content timing adjustments, before finalizing the presentation.

FIG. 4 is a slide count estimation table showing presentation type, speaking pace, and calculation logic used to determine the appropriate number of slides.

FIG. 5 illustrates an embodiment of a presentation generation flow, wherein user input parameters are processed by an AI language model to generate a speaker notes corpus, partitioned into segments corresponding to estimated slide counts, with each segment used to create a synchronized slide, demo placeholder, or video marker paired with speaker notes, culminating in editable time-constrained presentation content.

FIG. 6A illustrates a user input screen wherein the user is prompted to enter a presentation topic into a text field, with a disabled create button until a topic is provided.

FIG. 6B illustrates the same input screen after a topic has been entered, enabling the create button and expanding the input box if needed to accommodate longer text.

FIG. 7 illustrates an embodiment of a presentation customization interface, wherein the user confirms a presentation topic and selects additional parameters including presentation type, time duration, speaking pace with optional custom measurement, and speaker notes format before proceeding to content generation.

FIG. 8A illustrates an embodiment of a custom speaking pace determination interface, wherein the user records a sample reading to calculate a personalized words-per-minute (WPM) speaking rate for presentation pacing.

FIG. 8B illustrates an embodiment of a custom speaking pace confirmation interface, wherein the user's measured words-per-minute (WPM) speaking rate is displayed after completing a sample recording, with options to retake the recording or select “DONE” to confirm the result.

FIG. 9 illustrates an embodiment of a grid view interface for reviewing a generated presentation, wherein each slide, video, or demo preview is displayed as a tile with associated speaker notes or title and estimated duration, and the user can reorder the sequence prior to editing.

FIG. 10 illustrates an embodiment of a list view interface for reviewing a generated presentation, wherein each slide, video, or demo entry displays a preview image, speaker notes excerpt, estimated speaking time, and user controls to view details, regenerate speaker notes, delete the entry, or switch formatting between bullet points and full script.

FIG. 11A illustrates an embodiment of a detailed view interface for a generated slide and corresponding speaker notes, wherein the notes are displayed in bullet point format.

FIG. 11B illustrates the same detailed view interface as FIG. 11A, wherein the speaker notes are displayed in full script format and a pacing adjustment slider is provided for fine-tuning the estimated speaking time per slide.

FIG. 12 illustrates an example user interface of the AI assistant initiating a presentation creation flow, including topic input, presentation type selection, video upload, and assistant interaction options.

FIG. 13 illustrates an embodiment of the AI assistant interface for configuring time constraints and speaking pace, including time duration selection, speaking pace options, and voice measurement prompts.

FIG. 14 illustrates an embodiment of the AI assistant interface for selecting speaker note style and collecting final user input before generating the presentation.

FIG. 15A illustrates an embodiment of the AI-generated presentation tile preview interface, where the user can review the full presentation, interact with the AI assistant, and choose to continue to editing or refine content.

FIG. 15B illustrates an embodiment of a zoomed-in tile view of the AI-generated presentation preview, allowing the user to review individual slides, demos, or videos with associated timing and title information.

FIG. 16 illustrates an embodiment of the list view interface for previewing the AI-generated presentation, including speaker notes, estimated timing per slide, user editing actions, and AI assistant interaction options.

FIG. 17 illustrates an embodiment of the AI-assisted detail view interface, displaying slide visuals, speaker notes, and editable timing alongside conversational AI interaction for making slide-level adjustments.

### DETAILED DESCRIPTIONS

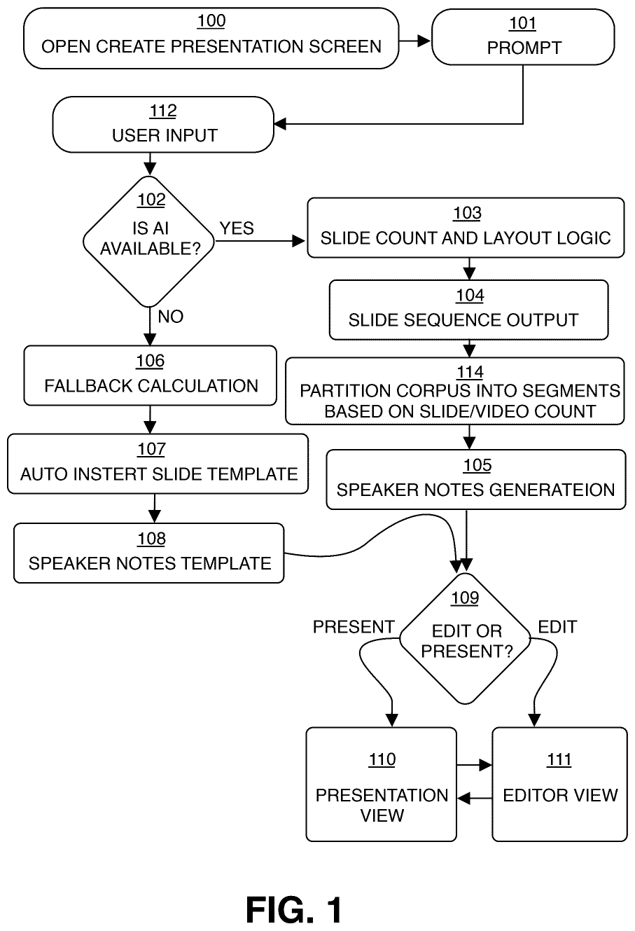

FIG. 1 illustrates an embodiment of a system workflow for generating time-constrained presentation content. The process begins at block (100), where the user opens the create presentation screen. The system then proceeds to prompt the user at block (101) to briefly describe their presentation goals, such as topic, audience, or delivery context. At block (112), the user inputs structured parameters including total presentation time, speaking pace, speaker notes format, and presentation type.

At decision point (102), the system determines whether an AI generation engine is available. If available, the system continues to logic block (103), which calculates the optimal number of slides and their structure based on user input. The ordered slide sequence is generated at block (104), and speaker notes are created at block (105), aligning with the pacing and duration constraints using AI-based techniques.

If AI is unavailable, the system enters a fallback path starting at calculation block (106), where it applies a formula to estimate slide count based on time and speaking pace. At block (107), predefined slide templates are inserted according to the presentation type. At block (108), speaker notes are pulled from a template database and scaled to match expected speaking duration.

Once slide and narration content are generated, the user is prompted at block (109) to choose between editing and presenting. If edit mode is selected, the system loads the editor interface at block (111). If presentation mode is selected, the full-screen presentation view is launched at block (110). This flow enables adaptive presentation generation regardless of AI availability, ensuring functional output in real-time.

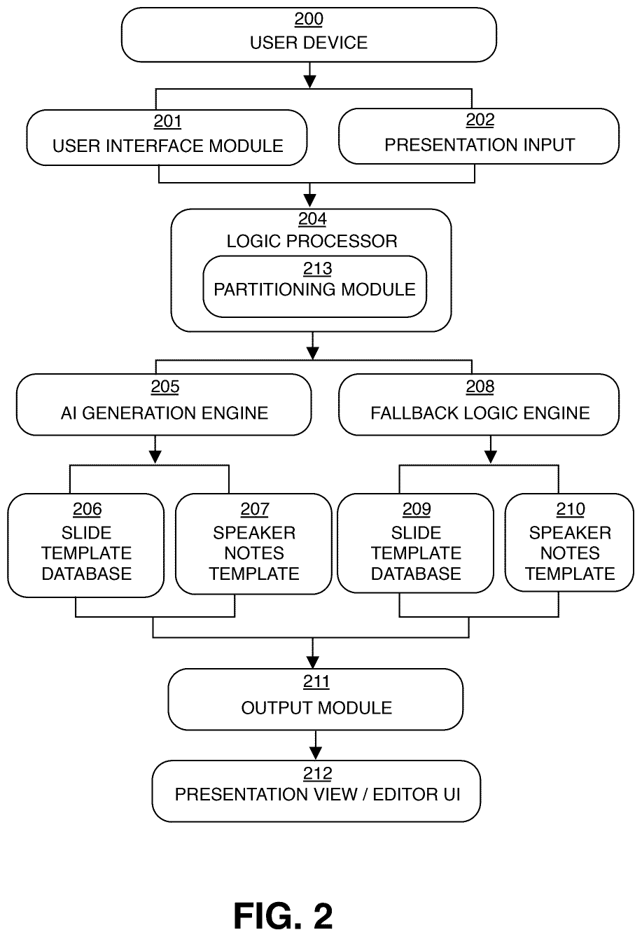

FIG. 2 illustrates the architecture of a system for generating time-constrained presentation content based on time, pace, and format parameters, in accordance with one or more embodiments. The system includes a user device (200), which houses a user interface module (201) and a presentation input module (202). These modules collect the presenter's preferences, including presentation type, duration, speaking pace, and desired speaker notes format.

The input is transmitted to a logic processor (204), which determines the appropriate generation path. The processor interfaces with an AI generation engine (105) and a fallback logic engine (206). Both engines are configured to access a shared slide template database (207) and a speaker notes template database (208). In one embodiment, the AI engine uses the templates as reference material to generate customized slides and speaker notes; in another embodiment, the fallback engine uses them as-is, inserting predefined content based on rule-based estimation.

The resulting slide sequence and narration data are passed to an output module (209), which delivers the content to either a presentation viewer (210) or an editor interface (211), enabling the user to preview, refine, and present the material.

This architecture supports intelligent, dynamic generation when AI resources are available, while ensuring functional performance via rule-based logic when offline or operating under constrained conditions.

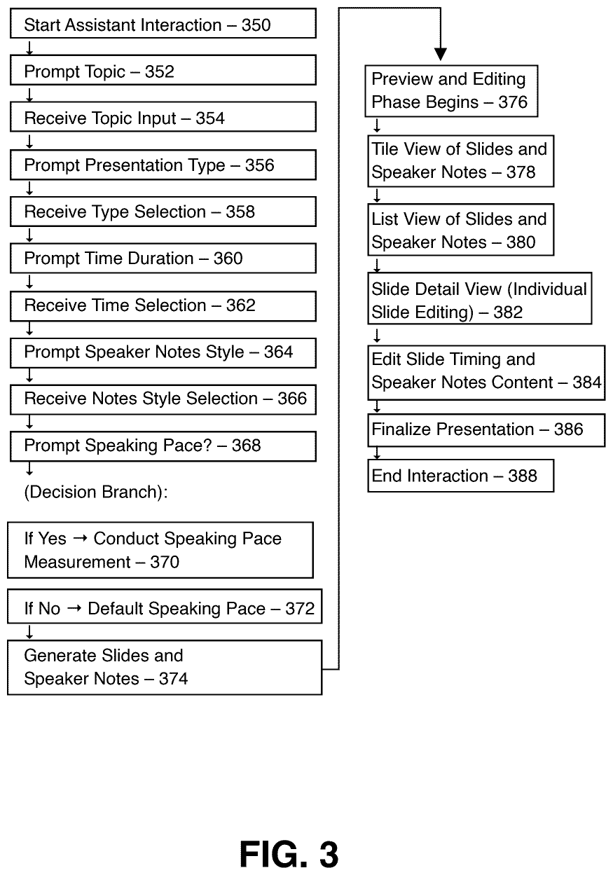

FIG. 3 illustrates an embodiment of a flowchart representing the interactive dialogue between an AI assistant and a user for configuring, generating, and reviewing time-constrained presentation content.

In alternative embodiments, the AI assistant interface may use voice input via speech recognition modules to receive user configuration preferences. System responses may be delivered via synthesized speech, enabling hands-free interaction.

In step (350), the AI assistant interaction begins. The system initiates a conversational flow, guiding the user through sequential inputs to configure a time-constrained presentation.

In step (352), the AI assistant prompts the user to input a presentation topic, which is received in step (354) and forms the foundation for slide generation.

In step (356), the user is prompted to select the presentation type. The selected type is stored in step (358) and determines layout logic and content density.

In step (360), the AI assistant prompts the user to enter a total time duration for the presentation, which is captured in step (362) and used for pacing calculations.

In step (364), the user is asked to choose a speaker notes style, such as None, Bullet Points, or Full Script. The user's selection is stored in step (366).

In step (368), the AI assistant asks if the user would like to measure their speaking pace. If so, a reading-based test is performed in step (370) to calculate a words-per-minute (WPM) value. If the user declines, a default pace is applied in step (372).

In step (374), the system generates a slide sequence and speaker notes aligned to the time duration, speaking pace, and content format preferences.

In step (376), the system transitions into a preview and editing phase, where the user can review and adjust the generated presentation.

In step (378), the system displays a tile view of all slides. In step (380), a list view is shown, including slide order and timing information.

In step (382), the user can access a detailed view of individual slides. In step (384), edits can be made to slide timing, speaker notes, and slide order.

In step (386), once all edits are finalized, the presentation is confirmed. The AI assistant interaction ends in step (388).

This assistant-guided workflow enables non-expert users to generate customized, time-constrained presentations with real-time content structuring, dynamic preview support, and editable pacing configurations.

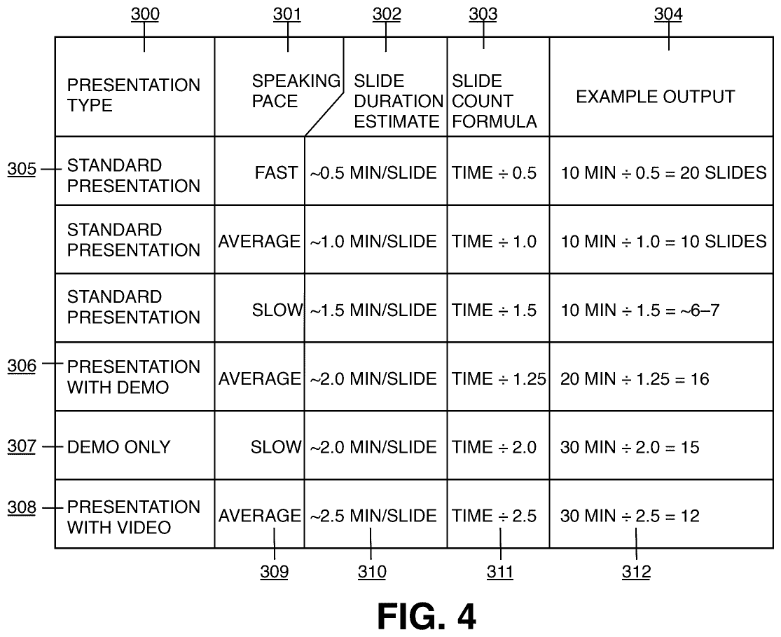

FIG. 4 illustrates an embodiment of a slide count estimation table based on user-defined presentation settings. The table includes five columns: presentation type (300), speaking pace (301), slide duration estimate (302), slide count formula (303), and example output (304).

Presentation types include standard presentation (305), presentation with demo (306), demo only (307), and presentation with video (308). Speaking pace options are defined as fast, average, or slow, where “AVERAGE” (309) represents an average delivery speed. Each row maps a specific combination of presentation type and speaking pace to a corresponding estimated slide duration (302), such as approximately ~2.5 minutes per slide (310).

The system selects the appropriate slide count formula (303) based on the user's chosen presentation type (300) and speaking pace (301). For example, the formula “TIME÷2.5” (311) is applied for a video-based presentation with average speaking pace. The resulting slide count is computed and shown as an example output (304), such as “30 MIN÷2.5=12” slides (312).

This logic supports both AI-assisted and fallback generation modes. In AI mode, the system may adapt these values dynamically to match user preferences and available time. In rule-based fallback logic, the table provides a rule-based method to estimate the number of slides prior to generation. This enables consistent pacing across different configurations and ensures presentations stay within the desired time constraints.

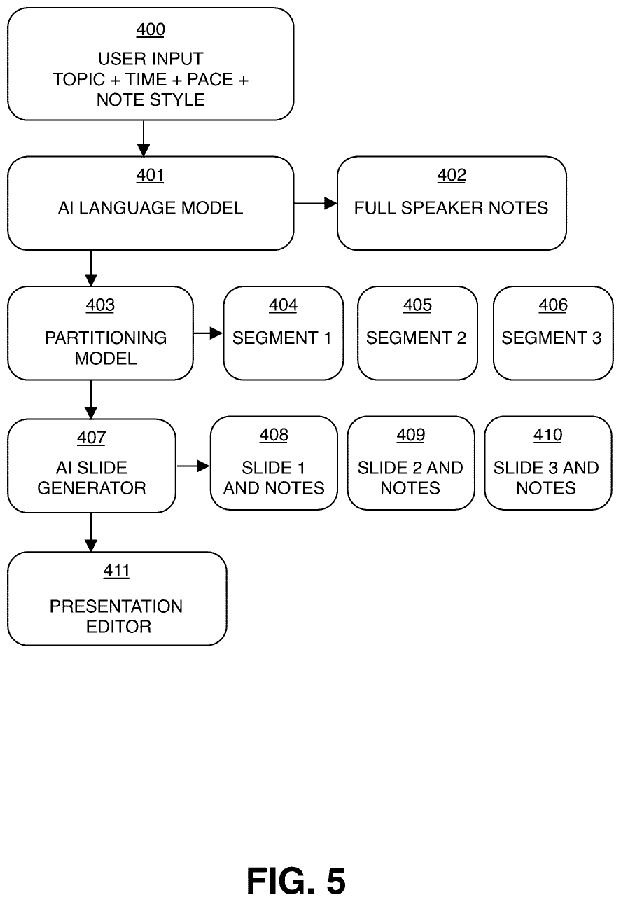

FIG. 5 illustrates an embodiment of a time-constrained presentation content generation flow based on user-defined parameters.

At block (400), the system receives user input including the presentation topic, total presentation time, desired speaking pace, and preferred speaker notes style (e.g., bullet points or full script).

At block (401), an AI language model generates a full speaker notes corpus (402) covering the requested topic within the specified time constraints.

The Partitioning Model (403) then divides the full speaker notes corpus into a set of segments (404, 405, 406) corresponding to the estimated number of slides needed, based on the user's total time and speaking pace preferences.

At block (407), the AI Slide Generator processes each segment. Depending on the selected presentation type, the AI Slide Generator creates a standard visual slide, a demo placeholder slide, or a video marker slide.

Each generated slide or content marker is paired with the corresponding portion of speaker notes, resulting in slide-note pairings (408, 409, 410) for each section of the presentation.

The completed sequence of slides, demo placeholders, video markers, and synchronized speaker notes is passed into the Presentation Editor (411), where users may preview, customize, and further edit their final presentation materials prior to delivery.

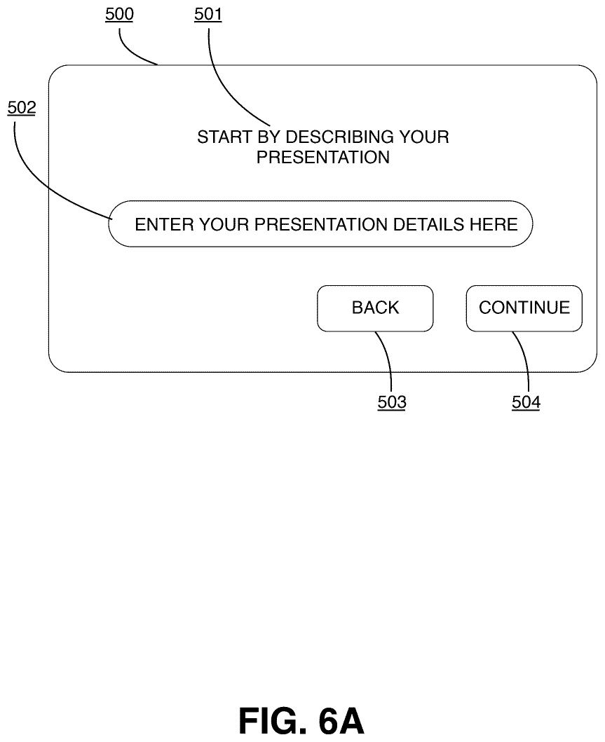

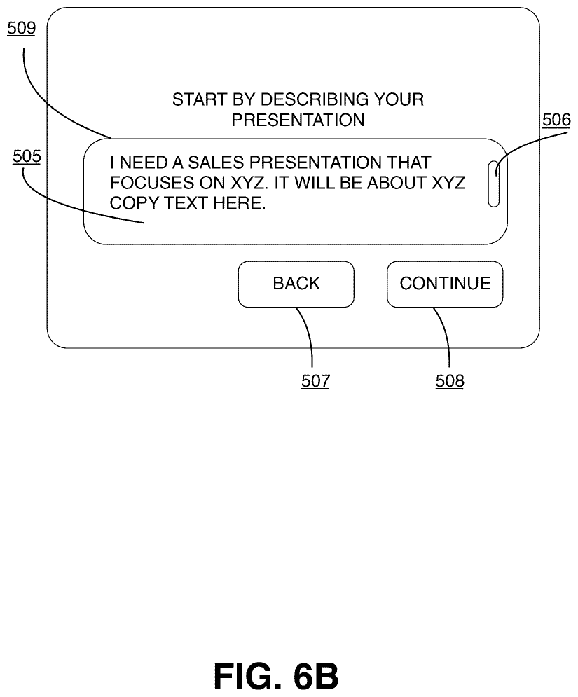

FIG. 6A illustrates an embodiment of an initial user interface for entering a presentation topic. The interface (500) displays a screen title (501) and a prompt label (502) instructing the user to enter a topic into a text area (505). A create presentation button (504) is initially disabled until the user begins typing into the text area. A scroll bar (506) is available to allow navigation through longer text entries if necessary. Optionally, a character counter (507) may display below the text field to indicate character limits.

FIG. 6B illustrates the same input interface after the user has begun entering a presentation topic. The create presentation button (508) becomes enabled, allowing the user to proceed. The text area (505) dynamically expands (509) to accommodate longer text entries, maintaining usability for both short and extended topics.

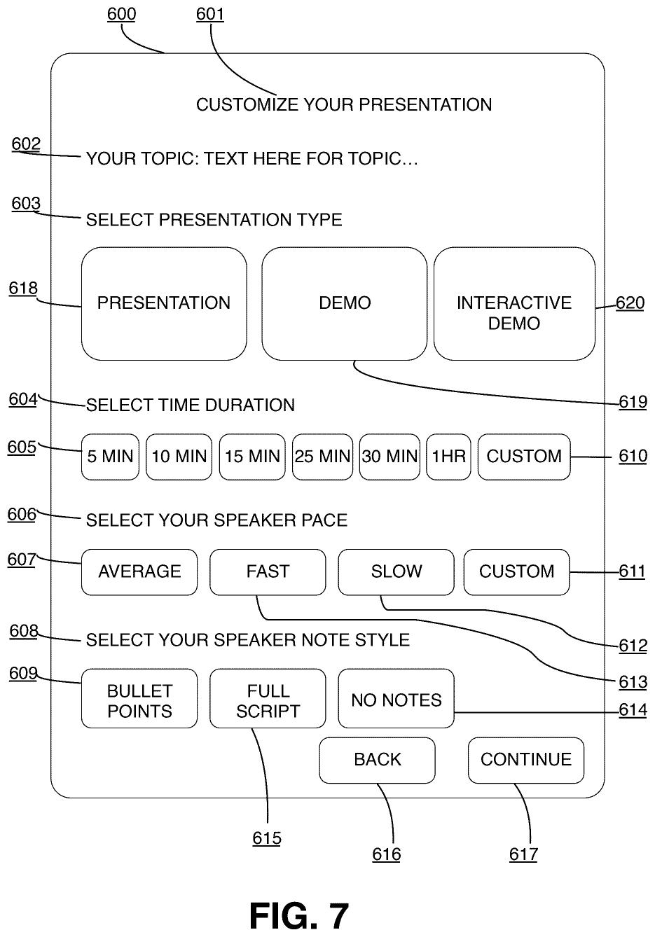

FIG. 7 illustrates an embodiment of a presentation customization interface.

After entering a presentation topic, the user is presented with a customizable options screen (600) displaying a screen title (601) and a confirmation of the entered topic (602).

The user selects a presentation type by choosing among presentation (618), demo (619), or interactive demo (620).

The user then selects a time duration (604) by choosing a predefined value such as 5 min (605) or entering a custom value using the custom (610) option.

The user proceeds to select a speaking pace (606), choosing between average (607), fast (613), slow (612), or initiating a custom (611) speaking pace measurement, which prompts the user to read a sample paragraph as detailed in FIG. 7.

Next, the user selects a speaker notes format (608), choosing between bullet points (609), full script (615), or no notes (614).

Navigation controls include a back (616) button to return to the previous screen and a continue (617) button to proceed with the generation of the time-constrained presentation content. The system uses these structured parameters to dynamically calculate slide pacing, speaker notes segmentation, and overall content structure.

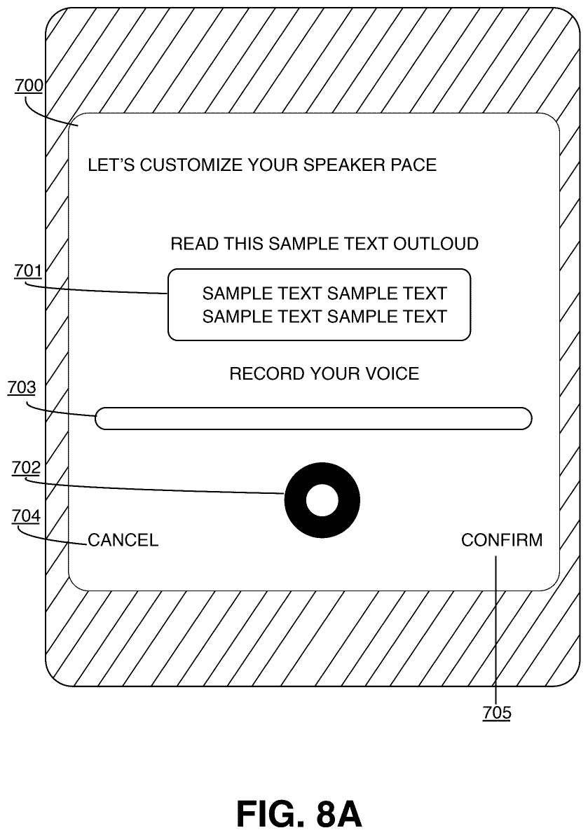

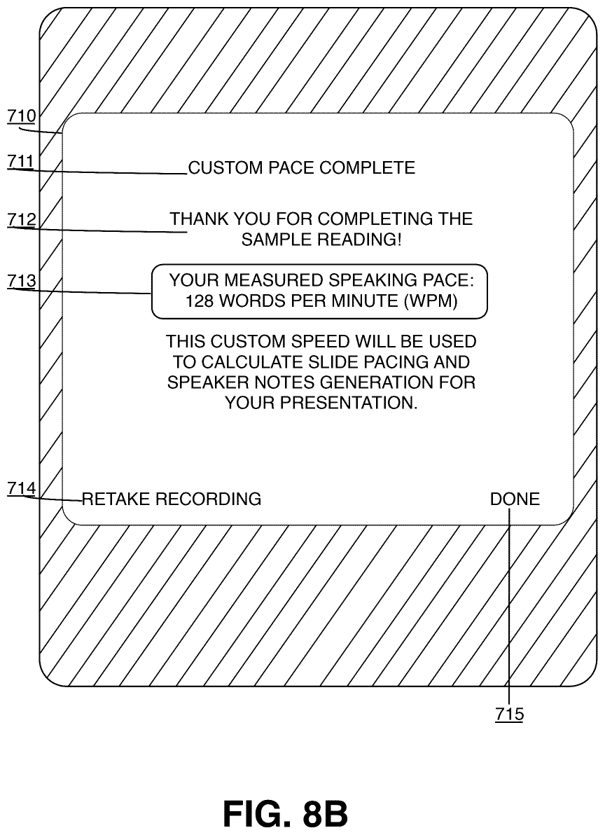

FIG. 8A illustrates an embodiment of a custom speaking pace measurement interface.

When the user selects the custom pace option (611) in FIG. 8A, a modal window (700) is displayed, prompting the user to read a sample text aloud.

The interface includes a sample paragraph (701) chosen to approximate typical presentation language and pacing. A record button (702) allows the user to begin recording their voice. During recording, a live progress bar (703) may indicate recording time or visual feedback of speech activity. Upon completion, the system calculates the user's words-per-minute (WPM) rate based on the recorded audio and uses the measured pace to dynamically adjust slide pacing and speaker notes segmentation for the generated presentation.

A cancel button (704) allows the user to discard the recording and return to the pace selection screen, while a confirm/save button (705) submits the measured speaking rate and proceeds with presentation generation using the personalized pacing information. FIG. 8B illustrates an embodiment of a custom speaking pace confirmation interface.

Upon completing the sample reading and recording in FIG. 7A, the system displays a confirmation modal (710) with a title (711) indicating successful completion. A message (712) thanks the user for completing the reading, and the calculated words-per-minute (WPM) speaking rate (713) is displayed prominently.

The user may choose to retake the recording by selecting the retake recording button (714) or confirm the measured pace by selecting the done button (715).

The confirmed WPM value is then used to adjust slide pacing and speaker notes generation for the customized time-constrained presentation content.

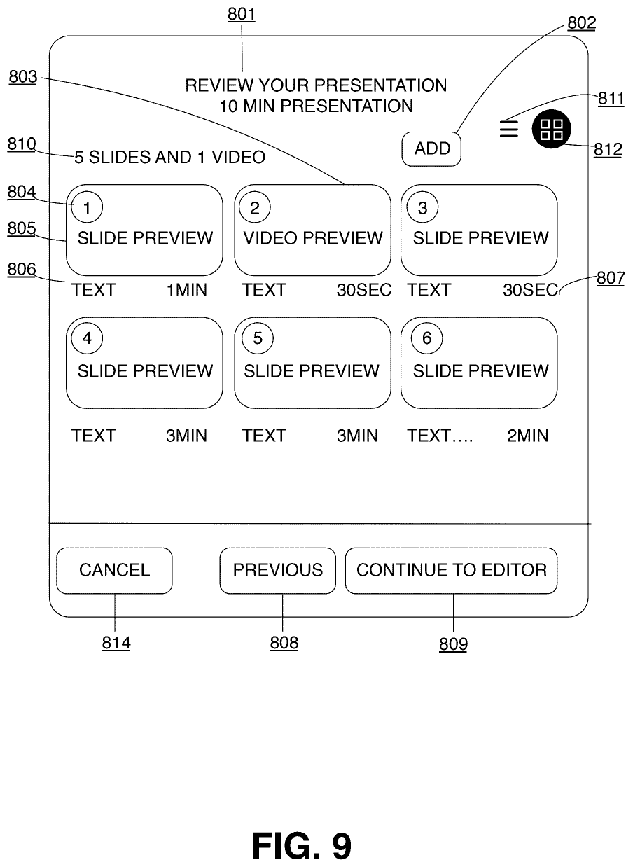

FIG. 9 illustrates an embodiment of a grid view interface for reviewing a generated presentation.

The interface (800) displays a screen titled “Review Your Presentation” and shows the total presentation duration, such as “10 Min Presentation” (801).

An overview summary (810) indicates the number of generated slides and videos, such as “5 slides and 1 video.”

An add button (802) allows the user to insert a new slide, video placeholder, or demo segment into the presentation sequence.

Each content unit, whether a slide, demo, or video, is displayed as a tile with a preview image (805) and a title or a short excerpt from the speaker notes (806). If the title or note exceeds one line, it is truncated with an ellipsis (“. . . ”).

Each tile also displays an estimated speaking time (807), such as “30 sec” or “1 min,” reflecting the expected delivery duration for that slide.

A sequential indicator (804) is included on each tile, showing the order of the slide or video within the presentation.

Users can reorder the slides, demos, or videos by dragging and dropping the preview tiles (805).

A toggle control is provided for switching between list view and grid view layouts, with 811 representing the list view option and 812 representing the grid view option. The grid view (812) is currently selected.

Navigation options at the bottom of the interface include a cancel button (814) that allows the user to exit the review process without proceeding, and a continue to editor button (809) that allows the user to move forward into the full presentation editor for slide and speaker notes refinement. If user wants to go back to make updates they can select Previous button (814).

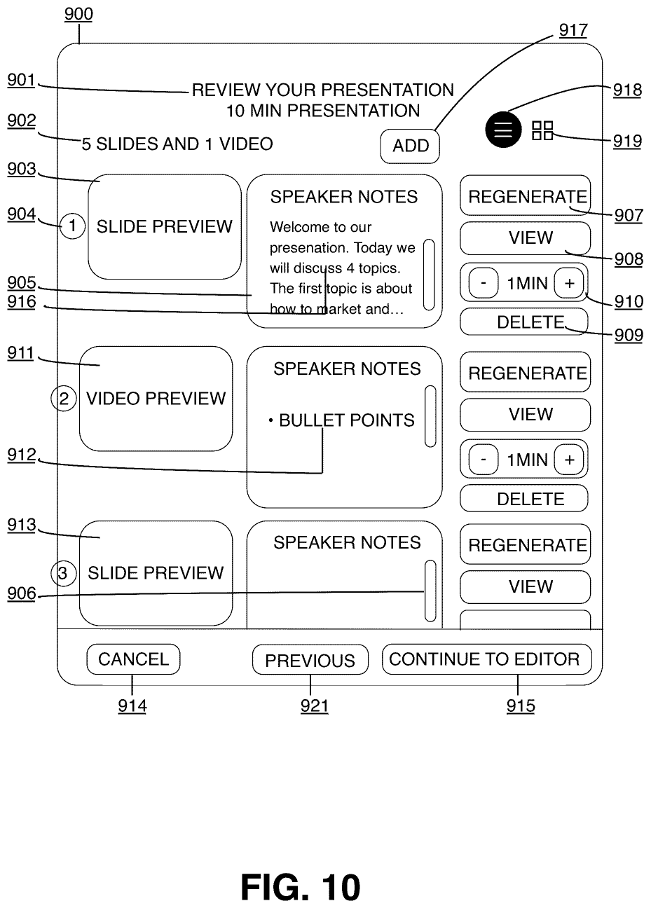

FIG. 10 illustrates an embodiment of a list view interface for reviewing a generated presentation.

Interface (900) displays a heading “Review Your Presentation” and a total-duration label (901), such as “10-min Presentation.” The label updates automatically when the user adjusts the time of any slide, demo, or video.

An add button (917) enables insertion of new slides, demos, or video markers into the sequence.

View-mode toggles include a list-view selector (918), which is active in this figure, and a grid-view selector (919).

Each list entry presents a thumbnail (903), an order number (904), a speaker-notes container (905) with optional scroll bar (906), and an estimated-speaking-time control (910).

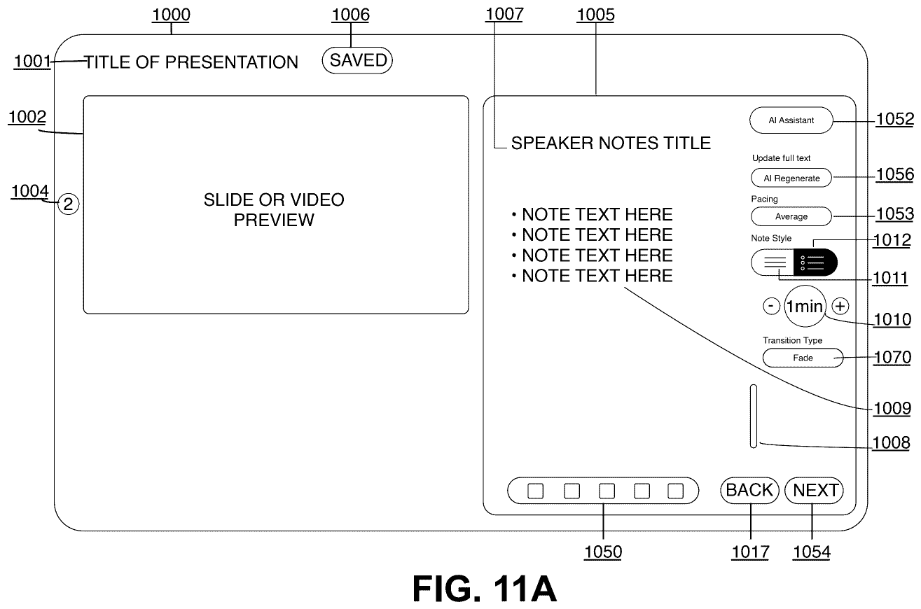

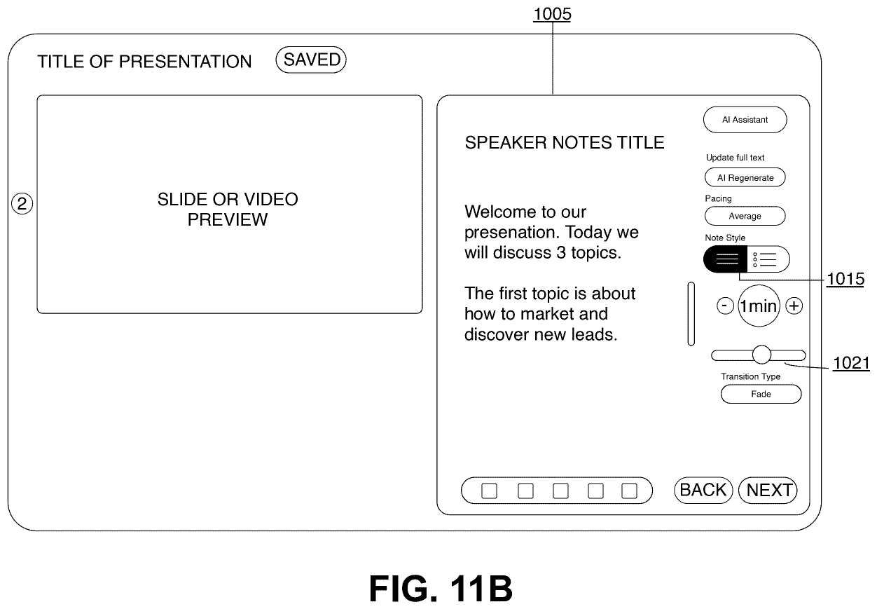

Entry-level controls for each list item comprise (i) a view button (908) that opens the detailed view of FIG. 11A, (ii) a regenerate-notes button (907) that prompts the AI engine to create revised speaker notes, (iii) a delete button (909) that removes the slide, demo, or video, and (iv) the speaking-time control (910).

The speaking-time control (910) provides “+” and “−” affordances; when adjusted, the displayed duration updates immediately and the presentation-generation logic recalculates pacing in real time.

The speaker-notes container (905) can display bullet-point style (912) or full-script style (916), depending on the selected note-format setting.

Navigation buttons at the bottom allow the user to cancel (914), return to the previous screen (915), or continue to the editor (921).

FIG. 11A illustrates one embodiment of a detailed view interface for a generated slide and corresponding speaker notes.

In this embodiment, interface (1000) shows the presentation title (1001) at the top and an auto-save confirmation status (1006).

A slide or video preview area (1002) is configured to display the visual content of the current slide or demo, with a slide-order label (1004) positioned adjacent to the preview.

Disposed to the right of the preview, a speaker-notes container (1005) may include a notes title (1007) and a vertical scroll bar (1008) for navigating longer text.

Notes content (1009) appears in bullet-point format, with the bullet-point toggle (1011) active; a full-script toggle (1012) is available but inactive in this figure.

Next to the notes, an estimated-speaking-time control (1010) operably displays the planned duration for the slide and provides “+” and “-” affordances. User adjustments cause the displayed duration to update immediately and trigger real-time pacing recalculation by the presentation-generation logic.

A side-panel toolset includes a back button (1017), the formatting toolbar (1050) for text styles and element links, a pacing-adjust button (1053), an AI-assistant button (1052), an AI-regenerate-notes button (1056), and a transition-type indicator (1070).

FIG. 11B illustrates a detailed-view interface similar to FIG. 11A, except that the speaker-notes container (1005) displays the notes in full-script format, with the full-script toggle (1012) selected.

In this embodiment, the interface additionally includes a pacing adjustment slider (1021) positioned adjacent to the estimated speaking time display. The pacing adjustment slider enables the user to fine-tune the estimated speaking time for the current slide by increasing or decreasing the assumed speaking rate, allowing minor adjustments without requiring full regeneration of the speaker notes or slide content. Adjustments made via the slider are reflected dynamically in the estimated speaking time display.

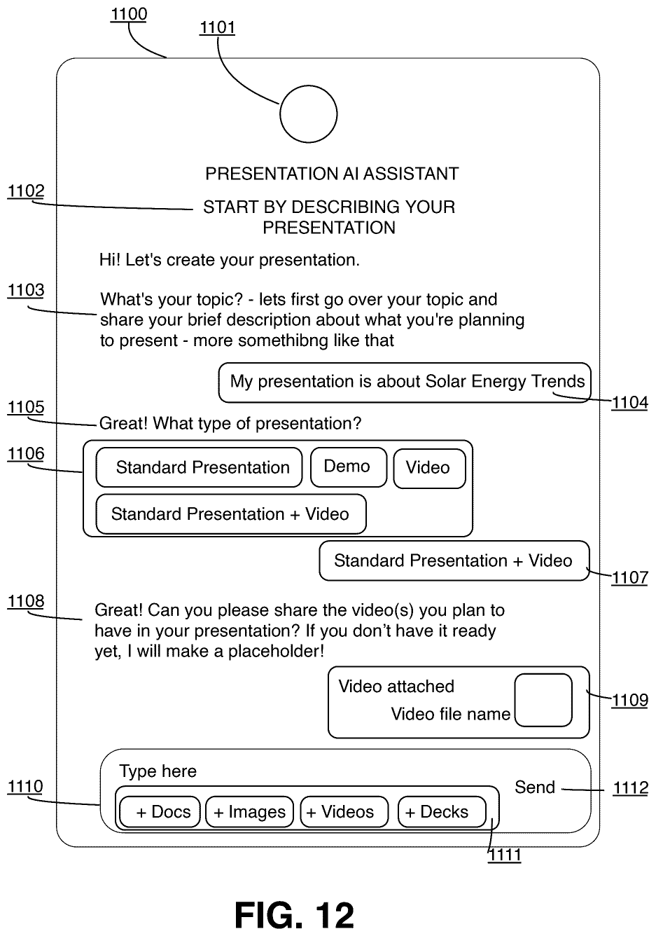

FIG. 12 illustrates an embodiment of a user interface presented when the user selects to create a presentation using the AI assistant. The interface includes a conversational flow area (1100) where messages between the AI assistant and the user are displayed. An assistant icon or logo (1101) appears near assistant-generated messages to distinguish them visually.

The upper portion of the interface includes a section header (1102) prompting the user to describe the presentation topic. The AI assistant initiates the interaction by asking for the topic (1103), and the user provides an input response (1104), such as a brief description of the presentation subject.

Based on the topic, the AI assistant responds with UI options (1105) related to presentation format. The AI assistant presents selectable presentation types (1106), including Standard Presentation, Demo, Video, and Standard Presentation+Video. The user selects a presentation type, in this case Standard Presentation+Video (1107).

Following the selection, the AI assistant prompts the user to upload a video file if available (1108). A file upload area (1109) allows the user to attach a video or indicate that a placeholder should be used.

Below the conversation area is a multi-input field (1110) for freeform user messages. Adjacent to this are additional upload options (1111), enabling the user to add documents, images, decks, or videos. A send button (1112) allows the user to submit the typed message or attached files to continue the conversation with the AI assistant.

This interface reflects the AI assistant's guided setup flow, enabling real-time, configurable input collection through a natural dialogue that dynamically adjusts based on user responses and content types.

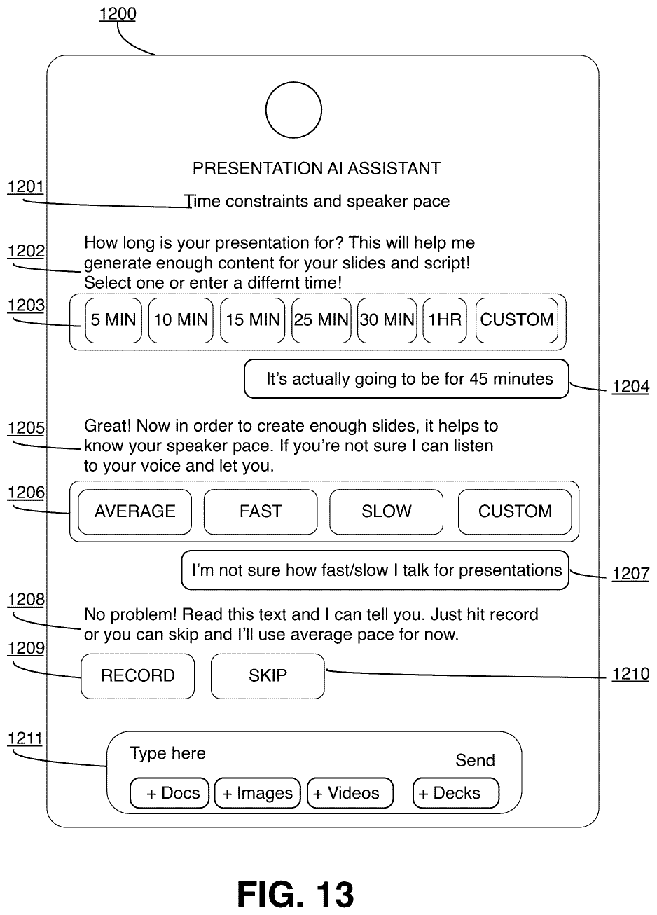

FIG. 13 illustrates an embodiment of the AI assistant interface presented to the user for configuring time duration and speaking pace constraints as part of a time-constrained presentation setup.

The interface (1200) includes a conversational dialogue area where the AI assistant guides the user through parameter selection. At the top, a section header (1201) indicates that the current configuration phase relates to time constraints and speaking pace.

The AI assistant prompts the user with a message (1202) asking, “How long is your presentation for?” Beneath the prompt, selectable time duration options (1203) are displayed, including 5 minutes, 10 minutes, 15 minutes, 25 minutes, 30 minutes, 1 hour, and a custom option. These suggested times may be dynamically generated based on the user's earlier responses or presentation type.

In this example, the user provides a custom time duration (1204), which the system captures to calculate pacing and slide allocation.

Following time selection, the AI assistant asks the user to select a preferred speaking pace (1205), such as average, fast, slow, or custom. These options are presented as selectable buttons (1206).

In this case, the user enters an ambiguous freeform response (1207), such as “not sure.” The AI assistant adapts accordingly and offers to measure the user's speaking pace via voice input or apply an estimated default (1208).

A record button (1209) is displayed to initiate a speaking pace test, and a skip button (1210) is available if the user prefers not to complete the test. A multi-use text entry field (1211), similar to that in FIG. 12, allows the user to submit questions or alternative responses at any time during the flow.

This assistant interface enables personalized timing calibration by combining structured options with adaptive dialogue, improving the accuracy of generated content pacing while supporting user flexibility.

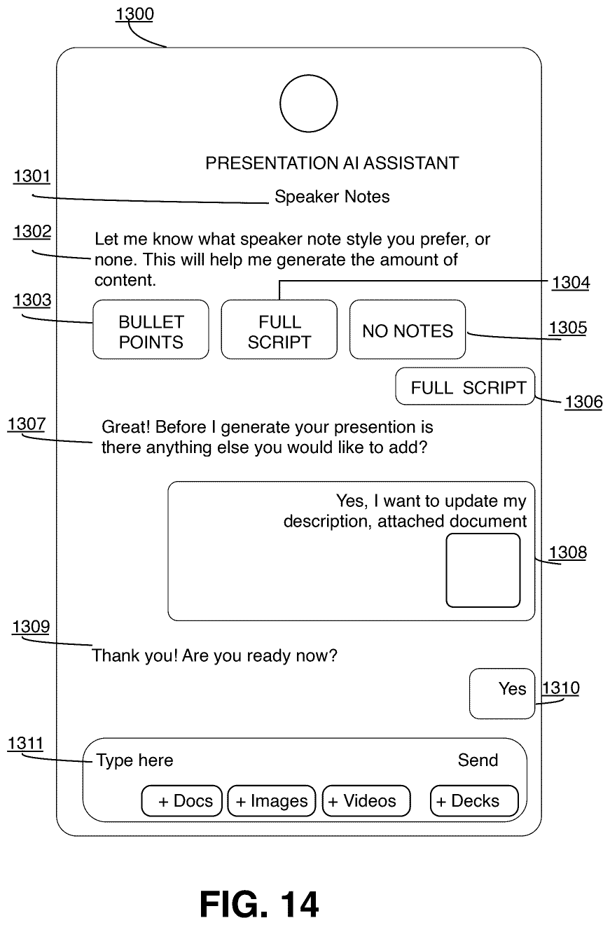

FIG. 14 illustrates an embodiment of the AI assistant interface where the user selects a preferred speaker note format and provides optional final inputs before the presentation is generated.

The interface (1300) includes the AI assistant-led conversation panel, where responses and user inputs are exchanged. At the top, a section header (1301) indicates that the current step pertains to speaker notes configuration.

The AI assistant asks the user to select a preferred speaker note style (1302), offering three choices: bullet point format (1303), full script format (1304), or no speaker notes (1305). These options allow the system to tailor the narration length and depth to the user's delivery preferences.

In the illustrated example, the user selects the full script option (1306), which will inform the system to generate comprehensive narration text aligned to the slide content.

After receiving the speaker note selection, the AI assistant prompts the user with a final opportunity to include additional content (1307), asking whether there is anything else the user would like to add before generation begins.

The user provides a freeform response (1308), such as, “Yes, I want to update my description, attached document.” This enables late-stage content additions, which may be processed and reflected in the generated slides.

The AI assistant then confirms with a readiness prompt (1309), such as, “Thank you! Are you ready now?” The user confirms readiness in response (1310), allowing the AI assistant to proceed to presentation generation.

A reusable text entry area (1311), consistent with the layout in FIG. 12, enables typed user responses and content attachments during the AI assistant interaction.

This interface allows the AI assistant to finalize presentation parameters through a structured but adaptable dialogue, ensuring content completeness and alignment with user delivery style prior to slide creation.

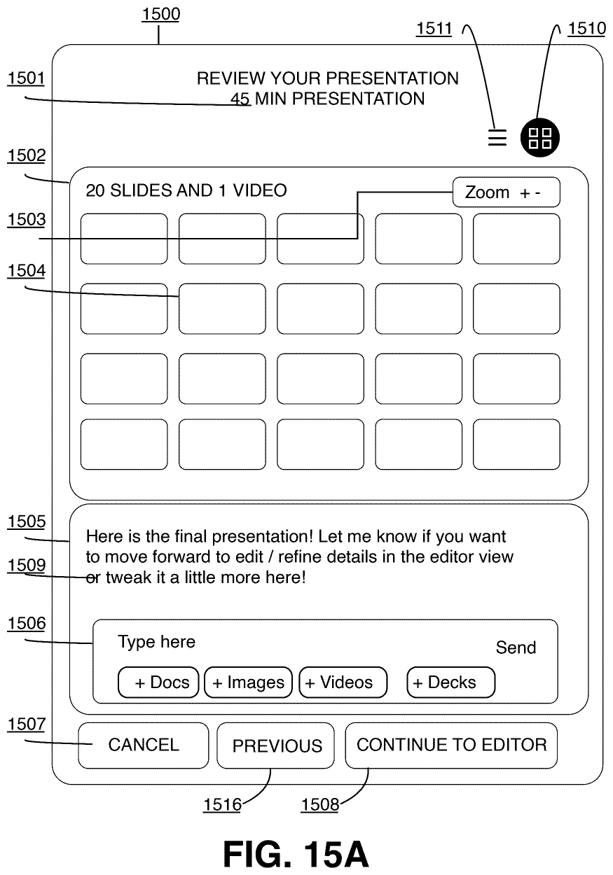

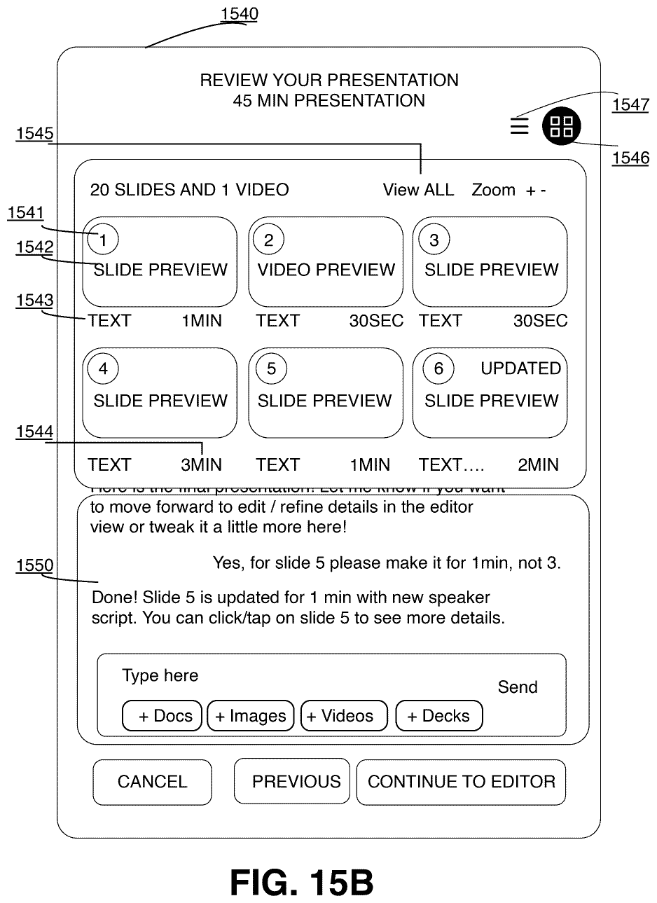

FIG. 15A illustrates an embodiment of the user interface showing the AI-generated presentation preview in a tile view format, allowing the user to review all content and engage with the AI assistant for any final refinements before entering the editor view.

The interface (1500) presents a high-level preview of the generated presentation. A title section (1501) displays the presentation name, estimated total duration, and a prompt to review the entire presentation before proceeding.

A preview area (1502) displays all generated slides and videos in a tile view, including the total number of slides and any media elements such as embedded videos or demo clips. The user can scan the entire flow visually before editing.

The interface includes zoom functionality (1503), enabling the user to magnify specific slide previews for better visibility and detail, as shown in FIG. 15B. The user can also drag and select for example 4 slides and then click on the+next to Zoom to view just those 4 slides.

A selected tile (1504) is highlighted in the preview area to represent the active slide or video element with its full visual layout.

A persistent conversational AI assistant area (1505) remains visible to support final feedback and refinements. The AI assistant provides a concluding message (1509), such as “Here is the final presentation! Let me know if you want to move forward to edit/refine details in the editor view or tweak it a little more here!”

A text box area (1506), consistent with previous interfaces (e.g., 1110), allows the user to type new messages or requests to the AI assistant. Below this, two action buttons are provided: a cancel button (1507) previous button (1516) and a continue button (1508) for advancing to the full editor view.

View toggles (1510, 1511) allow the user to switch between tile view and list view modes. In this example, the tile view toggle (1510) is selected, while the list view toggle (1511) is visible but inactive.

This interface supports an intermediate validation phase before the user enters full editing mode, enabling the AI assistant to make minor adjustments or confirm presentation readiness based on final user feedback.

FIG. 15B illustrates an embodiment of a user interface showing a zoomed-in view of the AI-generated presentation preview, following the user's selection to magnify specific content tiles.

The interface (1540) remains consistent with the presentation preview shown in FIG. 15A but adapts to a zoomed-in format to provide enhanced detail visibility.

A “View All” option (1545) is available, allowing the user to toggle back to an unfiltered overview of all slides, videos, and demos associated with the presentation.

Each slide or media item is displayed with a corresponding slide number (1541) indicating its sequential order in the presentation.

Individual content tiles (1542) display slide previews, demo previews, or video thumbnails, depending on the media type for that position in the sequence.

Text areas (1543) below each preview represent either the slide title, the beginning of speaker notes, or a descriptive label for video/demo content.

A duration indicator (1544) is associated with each content tile, showing the estimated or user-modified time allocated to that slide or media clip, supporting time-constrained pacing visibility.

Toggle controls for view modes are still present: tile view (1546) is selected in this example, while list view (1547) remains inactive but available for selection.

The bottom portion of the screen remains the same and the AI Assistant area (1550) functions the same in FIG. 15A.

This zoomed-in interface enhances user review by combining slide content, timing estimates, and organizational structure in a detailed but navigable layout, allowing fine-tuning before moving to the full editor.

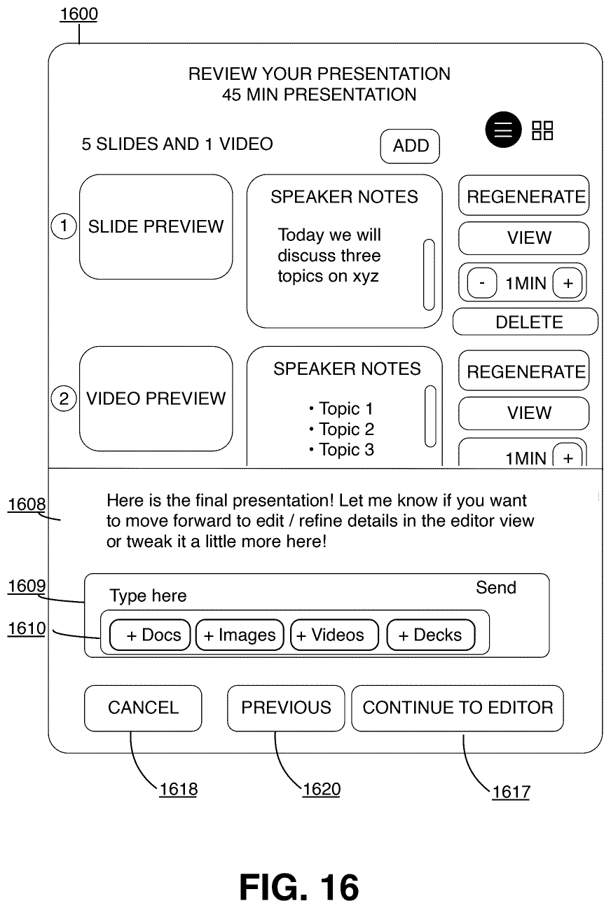

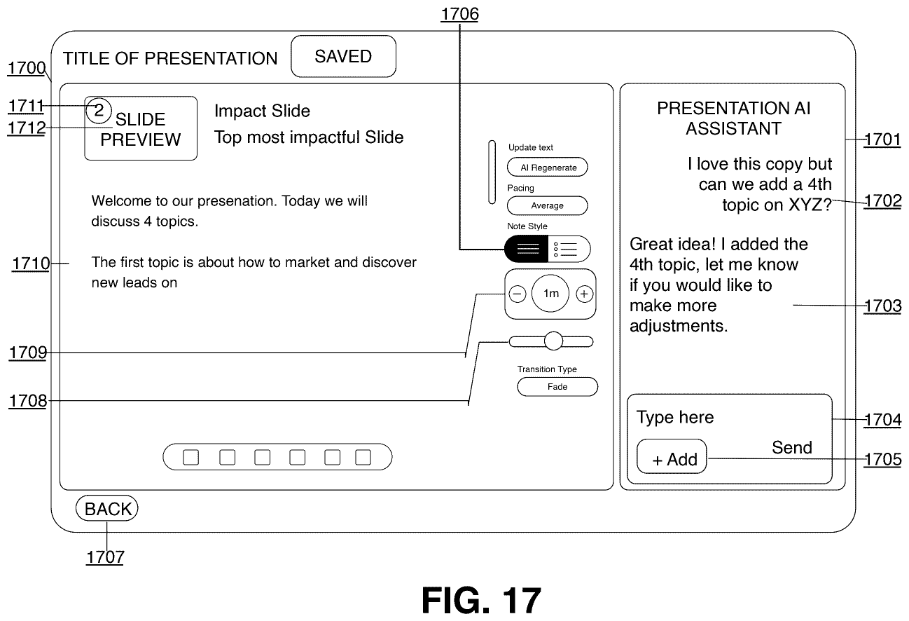

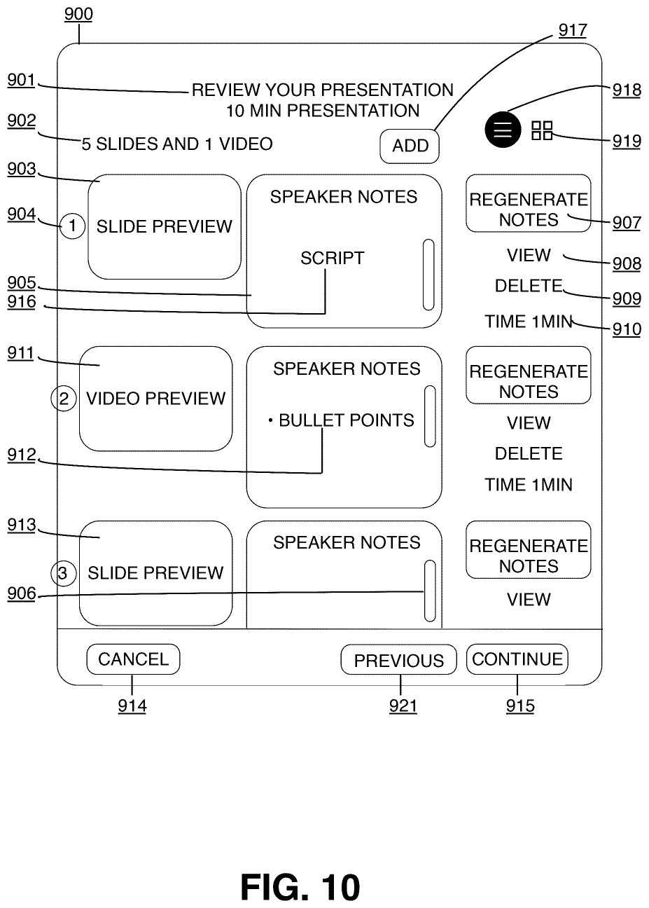

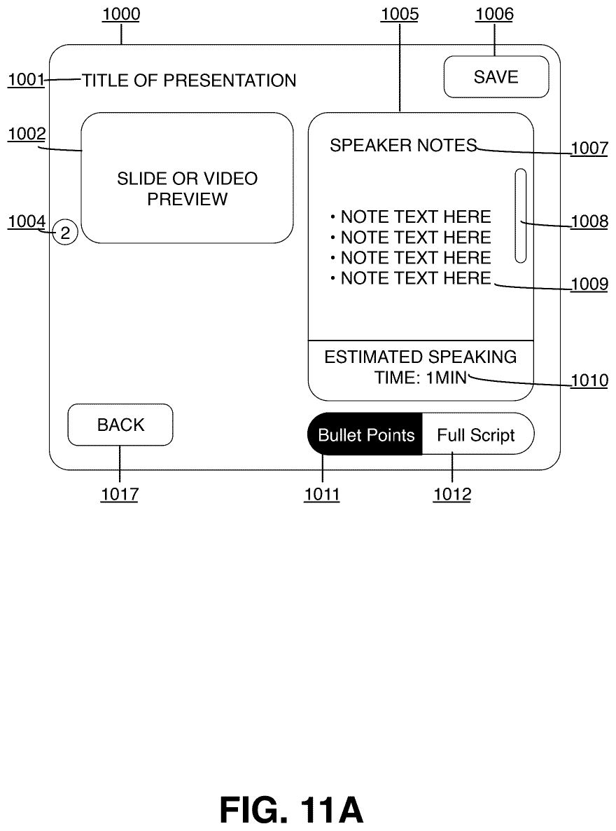

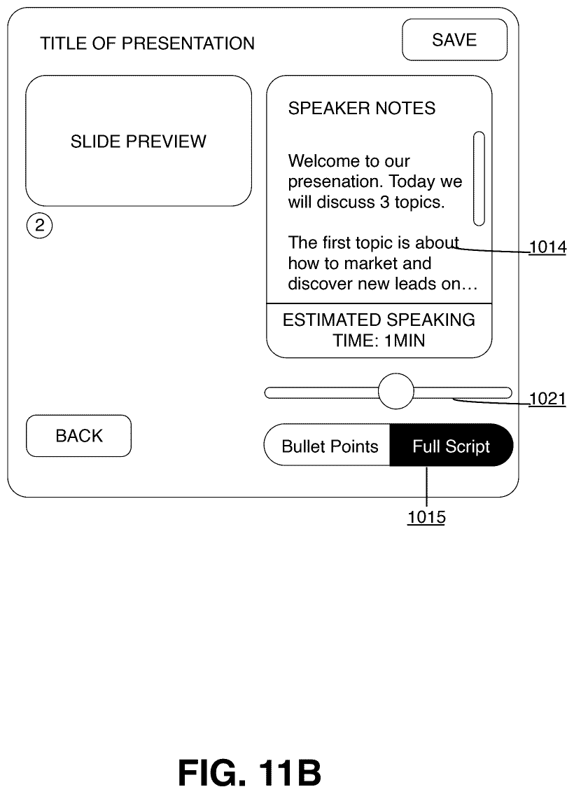

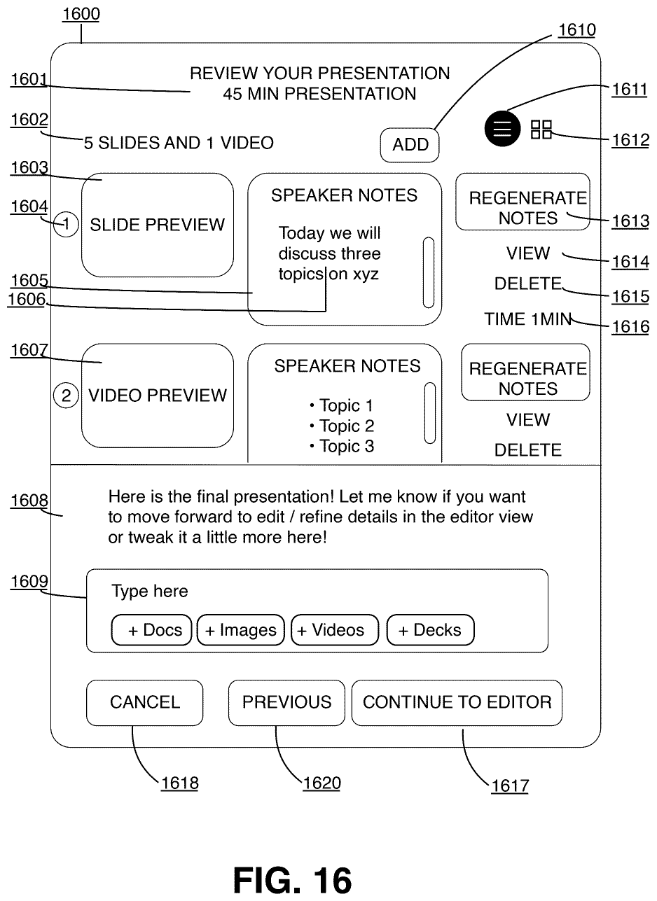

FIG. 16 illustrates one embodiment of a user interface that presents the AI-generated presentation in a list-view format, giving slide-by-slide details, timing controls, editing options, and continuous AI-assistant support. The upper region of this list view duplicates the core functionality of FIG. 10, while a dedicated AI-assistant panel occupies the lower region.

Interface (1600) displays the full presentation sequence in a vertically stacked list view. Each list item replicates thumbnail (903), order number (904), speaker-notes container (905) with optional scroll bar (906), and speaking-time control (910) as described in FIG. 10.

A heading area (1601) shows the presentation title and total duration, mirroring label (901). An add button (917) positioned near the heading lets the user insert new slides, demos, or video markers.

Beneath the list, an AI-assistant conversational panel (1608) remains visible during review. The panel includes a multi-purpose text box (1609) for user questions, modification requests, or additional content.

Direct-action buttons (1610) adjacent to the text box enable quick edits such as adding a new slide, demo, or video, invoking the regenerate-notes function, or launching AI pacing adjustments.

Navigation buttons at the bottom of the interface allow the user to cancel (1618), return to the previous screen (1620), or continue to the full editor view (1617) after confirming the list-view preview.

This list-view interface provides comprehensive control over slide content, timing, and structure before the user enters the deeper editor environment, while maintaining dynamic AI-assistant engagement for real-time refinements.

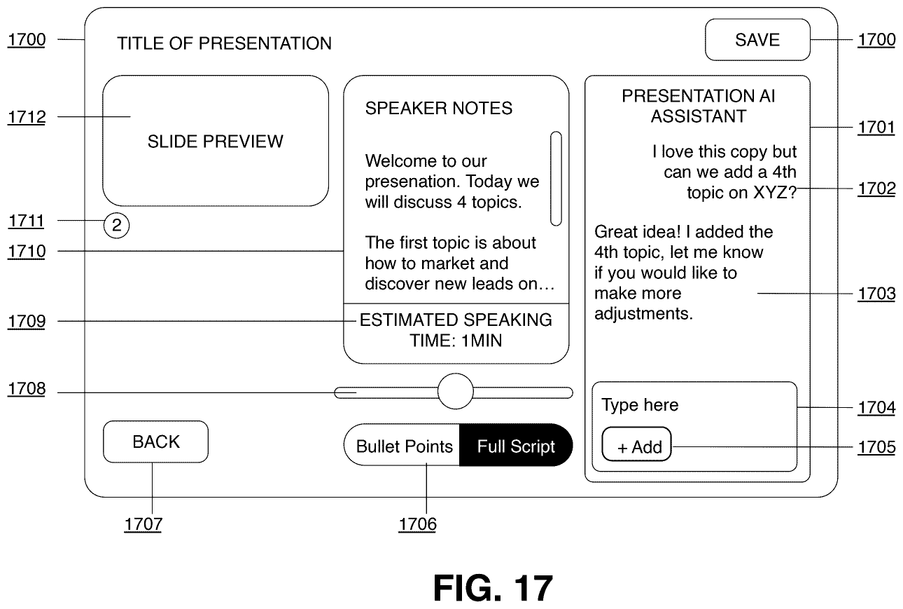

FIG. 17 illustrates one embodiment of a detail-view interface in which slide content and speaker notes are displayed side by side with dynamic AI-assistant interaction for real-time refinement and pacing control.

Interface (1700) presents a single-slide editing view that allows users to refine speaker notes, adjust delivery time, and engage with the AI assistant without leaving the slide context.

A conversational assistant panel (1701) shows the dialogue between the user and the AI assistant. In the depicted interaction, the user submits a free-form request (1702)—for example, adding a fourth topic—and the assistant responds in panel message (1703), confirming the change and inviting further adjustments.

A multi-purpose text box (1704), functionally consistent with text boxes 1110 and 1609, lets the user type additional questions or content. An attachment button (1705) permits files or images to be inserted into the conversation.

A notes-format toggle (1706) enables switching between bullet-point and full-script styles. A navigation back control (1707) returns the user to the tile view for broader context.

A pacing-adjustment slider (1708) increases or decreases note density, thereby influencing delivery duration. An estimated-speaking-time control (1709) shows the current duration—e.g., “1 MIN”—and provides “+” and “−” affordances, as described for speaking-time control (1010) in FIG. 11A.

Speaker-notes container (1710) holds the editable text for the current slide, while a slide-order label (1711) indicates the slide's position within the full sequence.

A visual thumbnail (1712) presents the slide layout, video frame, or demo preview, depending on content type.

This detail view supports slide-level customization with continuous assistant engagement, enabling real-time collaboration, pacing calibration, and dynamic editing without disrupting the larger presentation structure.

1. A system for generating time-constrained presentation content, the system comprising: a user input module configured to receive presentation parameters including a presentation topic, presentation type, total presentation duration, speaking pace selection, and speaker notes format selection; a generation engine configured to dynamically generate a slide sequence and corresponding speaker notes content aligned to the total presentation duration and speaking pace; a fallback logic engine configured to generate time-constrained slide and speaker notes content based on pre-defined estimation rules when an AI-based generation engine is unavailable; and an output module configured to provide the generated content for user editing or direct presentation.

2. A method for generating time-constrained presentation content, comprising: receiving, via a user interface, input defining a presentation topic, a total time duration, a speaking pace, and a speaker notes format; generating, by an AI generation engine, a slide sequence and corresponding speaker notes structured to fit within the total time duration based on the speaking pace; applying fallback logic to generate slide and speaker notes content using rule-based estimation when the AI generation engine is unavailable; and providing the generated presentation content to a user for editing or direct delivery.

3. A non-transitory computer-readable medium storing instructions that, when executed by a processor, cause the processor to perform operations comprising: receiving presentation configuration parameters comprising a topic, total time duration, speaking pace, and speaker notes format; generating a set of slides and corresponding speaker notes structured to fit the total time duration at the specified speaking pace using either an AI generation engine or a fallback estimation module; and outputting the slide and speaker notes sequence for user review, editing, or presentation.

4. The system of claim 1, wherein the speaking pace is determined based on a user-recorded sample of verbal delivery and a calculated words-per-minute (WPM) rate.

5. The system of claim 1, wherein the speaker notes include a displayed time estimate associated with each slide or section.

6. The method of claim 2, wherein the presentation type is selected from the group consisting of Standard Presentation, Demo, Presentation with Demo, and Presentation with Screen Recording or Video, and wherein the selected presentation type influences the structure, media inclusion, or tone of the generated slides and speaker notes.

7. The method of claim 2, further comprising dynamically adjusting the number of slides based on the selected speaking pace and total presentation duration.

8. The method of claim 2, further comprising providing an editable preview interface wherein the user may modify, reformat, or regenerate speaker notes prior to finalizing the generated presentation.

9. The method of claim 6, further comprising calculating and displaying an estimated number of slides, video segments, or demo elements based on the user-provided presentation duration, selected speaker notes format, and speaking pace.

10. A system for generating presentation content using an interactive AI assistant, the system comprising: an AI assistant dialogue engine configured to interact with a user through a sequence of conversational prompts to collect presentation configuration parameters including topic, type, time duration, and speaking pace; a pacing model engine configured to estimate slide count and content density based on real-time user responses; an adaptive content generator configured to dynamically update slide and speaker notes content as new responses are received; and a presentation output module configured to finalize the time-constrained presentation content for delivery or editing.

11. The system of claim 10, wherein the AI assistant dialogue engine presents each prompt in a chat-style user interface and updates subsequent questions based on prior responses.

12. The system of claim 10, wherein the adaptive content generator presents real-time slide count previews and speaker note summaries to the user during the interaction.

13. The system of claim 1, further comprising a user interface control that allows the user to toggle between speaker note formats including bullet point outline and full script view.

14. The system of claim 1, wherein the AI assistant presents the generated presentation content in at least three view modes: tile view, list view, and slide detail view.

15. The system of claim 10, wherein the AI assistant interface provides an estimated delivery time per slide and allows the user to adjust pacing using a visual slider.

16. The system of claim 10, wherein the AI assistant applies a predefined default speaking pace when the user skips the speaking pace measurement step, enabling slide and narration pacing to proceed without user-provided speed data.

17. The system of claim 10, further comprising an input area that enables the user to attach documents, videos, or images for inclusion in the generated presentation content.

18. The system of claim 10, wherein the AI assistant interface comprises a visual layout including a conversational dialogue area, configurable presentation options, and a dynamic preview panel supporting tile, list, and slide detail views.

19. The system of claim 10, wherein the AI assistant interface includes a voice-based interaction mode, wherein user inputs are received through speech recognition and AI assistant responses are delivered via speech synthesis or audio playback, and wherein presentation parameters including topic, duration, and speaking pace are configured through verbal dialogue.

20. The system of claim 10, wherein the conversational interface and presentation output are integrated within a unified UI that dynamically updates estimated delivery time, slide count, and speaker note content based on real-time user responses.

21. The system of claim 1, further comprising a graphical user interface configured to:
(a) display a list view that presents a presentation sequence as vertically stacked entries, each entry including:
(i) a preview image;
(ii) a speaker-notes container; and
(iii) an estimated-speaking-time control that, responsive to user input, triggers automatic recalculation of pacing for the corresponding entry;
(b) display a grid view that presents the same sequence in a matrix of tiles, each tile showing a preview image, a title or speaker-notes excerpt, and an estimated-speaking-time label synchronized with the list-view control;
(c) display a slide-detail view that presents, side by side, a full-resolution slide preview and its speaker notes, the slide-detail view further comprising:
(i) a pacing-adjustment slider operable to fine-tune the estimated speaking time for the slide; and
(ii) an AI-assistant panel configured to receive natural-language user input and, in response, regenerate or edit speaker notes and recalculate pacing; and
(d) maintain bidirectional synchronization of slide order, speaker-notes content, and estimated pacing across the list view, grid view, and slide-detail view.
